(19) United States
(12) Patent Application Publication
(10) Pub. No.: US 2014/0366837 A1
(43) Pub. Date: Dec. 18, 2014

(54) SPLIT-CYCLE-ENGINE MULTI-AXIS HELICAL CROSSOVER PASSAGE WITH GEOMETRIC DILUTION

(71) Applicant: Gerald John Wawrzeniak, Longmeadow, MA (US)

(72) Inventor: Gerald John Wawrzeniak, Longmeadow, MA (US)

(21) Appl. No.: 13/969,391

(22) Filed: Aug. 16, 2013

Related U.S. Application Data
(60) Provisional application No. 61/683,799, filed on Aug. 16, 2012.

(51) Int. Cl. F02B 31/00; F02B 21/00

(52) U.S. Cl. CPC F02B 31/00; F02B 21/00
USPC 123/308

(57) ABSTRACT

The current application is directed to mechanical devices that mix gasses, including an end section of a split cycle engine crossover passage. The end section forms, using high-pressure air from the crossover passage and fuel from the injector, a swirling, entwined mixture on multiple axes with distributed rotational frequencies that results in a superior air/fuel mixture. Additionally, by appropriately dividing the air and geometrically entwining the mixture from each of the parallel stages, the end section provides for geometric dilution of the air/fuel mixture. Multiple-axis swirling can be introduced into many

### CROSS-REFERENCE TO RELATED APPLICATION

This application claims the benefit of Provisional Application No. 61/683,799, filed Aug. 16, 2012.

### TECHNICAL FIELD

The current application relates to internal combustion engines and, in particular, to mechanical components that mix gasses, including an end section of a split-cycle engine having a compression cylinder and a combustion cylinder interconnected by one or more crossover passages.

### BACKGROUND

The split-cycle engine shown in FIG. 1 replaces a single cylinder of a four-cycle engine with a combination of one compression cylinder 111 and piston 101 and one combustion cylinder 109 and piston 105. These two cylinders perform their respective functions once per crankshaft 110 revolution. The intake air is drawn into the compression cylinder 111 through an intake valve 102. The compression piston 101 pressurizes the air and drives the air through the crossover passage 107, which acts as the intake passage for the combustion cylinder 109. The air charge enters the combustion cylinder 109 shortly after combustion piston 105 reaches its top dead-center position. As this happens, a fuel injector 112, located in either the crossover end piece 107 or the cylinder 109, injects the fuel. Spark plug 108 is fired soon after the intake charge enters the combustion cylinder 109 and the resulting combustion drives the combustion piston 105 down. Exhaust gases are pumped out of the combustion cylinder through the exhaust valve 106.

FIG. 2 shows a diagram of the current state-of-the-art for a helical-crossover-passage end piece of a split cycle engine. The end piece forms a helix about a single axis and produces a swirling mixture about the single axis. The axis of a helix is the axis about which the turns of the helix are wound. The straight portion 207 is a connecting passage to the compression cylinder 111 of FIG. 1. FIG. 2 shows an approximate ¾ turn helical section beginning at point 201 and beginning to end at 203 as it starts entering the valve port. This end piece design produces a swirling mixture 204 which is perpendicular to the Valve Stem 205 whose rotation may either be designed to be clockwise or counter-clockwise. An advantage of this type of end piece is that it converts the high pressure air into a high-speed swirling vortex with extreme turbulence for mixing the fuel/air charge. A disadvantage is that the high-speed rotational air also forms the foundation of a gas centrifuge. A gas centrifuge works to separate heavier and lighter gases, thus working against the mixing process and forcing the heavier gas droplets to the outside circumference of the cylinder walls.

### SUMMARY

The current application is directed to mechanical devices that mix gasses, including an end section of a split cycle engine crossover passage. The end section forms, using high-pressure air from the crossover passage and fuel from the injector, a swirling, entwined mixture on multiple axes with distributed rotational frequencies that results in a superior air/fuel mixture. Additionally, by appropriately dividing the air and geometrically entwining the mixture from each of the parallel stages, the end section provides for geometric dilution of the air/fuel mixture. Multiple-axis swirling can be introduced into many additional types of channels, tubes, and passageways according to the current application.

### BRIEF DESCRIPTION OF THE DRAWINGS

FIG. 1 shows a split-cycle engine.

FIG. 2 shows a diagram of the current state-of-the-art for a helical-crossover-passage end piece of a split cycle engine.

FIG. 3 shows a multi-helical end piece with two helixes, each oriented about a different axis.

FIG. 4 shows a multi-axis helical crossover passage end piece that implements geometric dilution.

FIG. 5 and FIG. 6 are diagrams of the third and fourth alternative implementations of the multi-axis helical crossover passage end piece.

FIG. 7 shows an inversion of the helical tube sequence that mixes geometrically in sequence within the tubes.

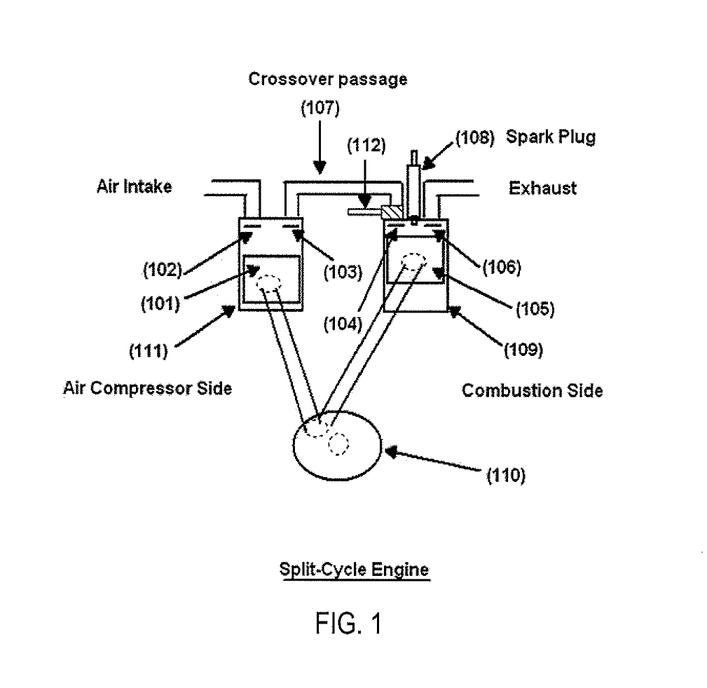

### DETAILED DESCRIPTION

The current application is directed to mechanical devices that mix gasses, including an end section of a split cycle engine crossover passage. The following five terms and phrases are used in the discussion that follows:

(1) Four-cycle engine refers to an internal combustion engine in which all four strokes of the well known Otto cycle (i.e., the intake, compression, combustion, and exhaust strokes) are contained in each piston/cylinder combination of the engine.

(2) Split-cycle engine refers to an internal combustion engine where the four strokes of the Otto cycle for each cylinder are divided between two cylinders of a cylinder pair. The first cylinder performs intake and compression. The second cylinder performs combustion and exhaust. The two split-cycle cylinders are interconnected with a crossover passage 107 separated at one end by a crossover compression valve 103 on the compression cylinder and at the other end by crossover combustion valve 104 on the combustion cylinder, defining the pressure chamber/crossover passage between them.

(3) Geometric Dilution is a process by which a homogenous mixture or even distribution of two or more substances is achieved. The smallest quantity of active ingredient (in this case fuel) is mixed thoroughly with an equal volume of the diluents (in this case air) by this process. More diluent (air) is added in amounts equal to the volume of the previous mixture. This process is repeated until all of the diluent (air) is incorporated in the mixture.

(4) A Swirl refers to the resultant air vortex created by high-pressure and low-pressure areas created the air by passing the air through a helical tube.

(5) A Twist is force applied to air or to an air/fuel mixture as it passes through a helically shaped tube.

### Multiple Axis Helical Crossover Passage

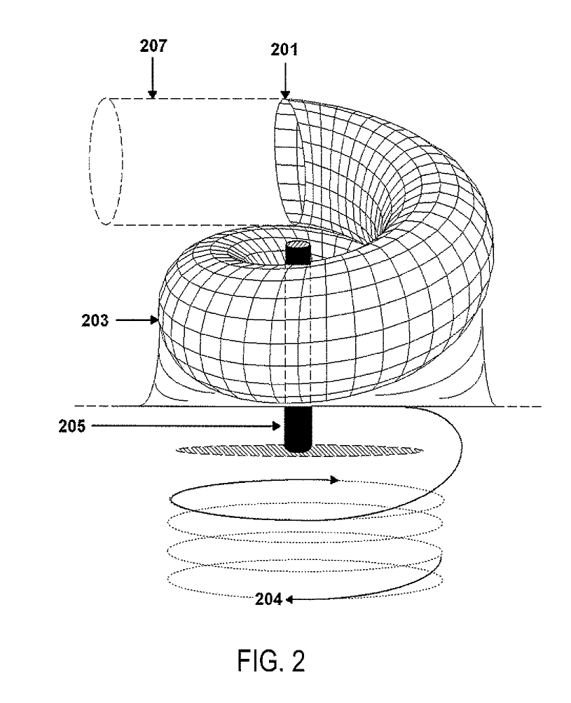

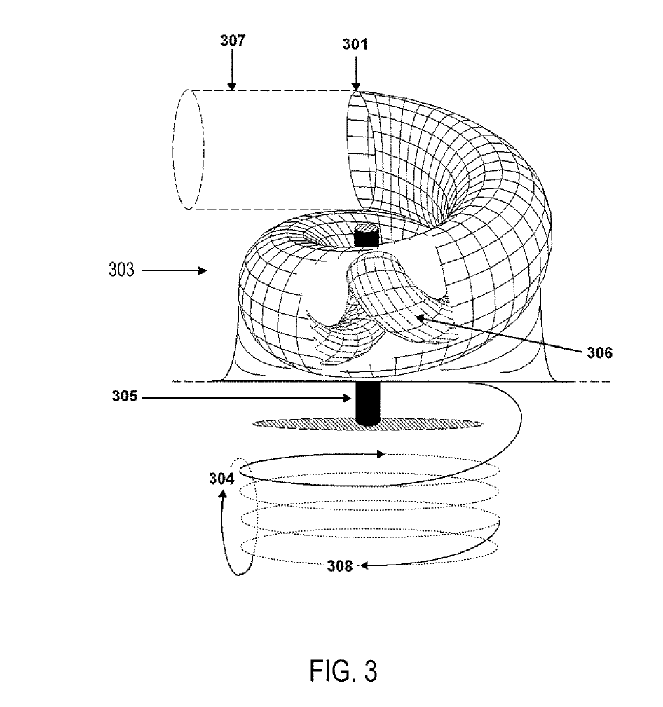

FIG. 3 shows a multi-helical end piece with two helixes, each oriented about a different axis. The two helixes can be used to create an air/fuel mixture swirl about two axes. The helical section from 301, which is the beginning of the helical portion, forms a swirl 308 in the mixture perpendicular to the valve stem 305 and helical section 306 forms a swirl in the mixture 304 parallel to the valve stem 305. Section 306 is shown as a separate helical tube for illustrative purposes only. The two different helical sections are incorporated into a single, continuous tube or passageway, in many implementations. The combustion intake valve 305 is shown opening away from the helical crossover end piece and into the combustion cylinder for ease of illustration only. Section 306 can be implemented as a second helical twisting of the main helical section, creating a swirl parallel to the valve stem 305 which is on a different axis to the main helical section 301 which forms a helix perpendicular to the valve stem 305. This second helix may or may not extend from section 301 to section 303, but only for a portion of this extent. This flexibility in design allows a designer to dictate the amount of rotational energy and rotational frequency input into each rotational axis. The centrifuge effect of the single axis helix of FIG. 2 is negated and used to an advantage as the second helical swirl 304 rotates material from the outer cylinder walls back into center. This dual helix effect can be thought of in the following manner. The multi-helical end piece takes the same rotational energy that is put into the air/fuel mixture in a single helical end piece and divides this rotational energy into separate swirls 304 and 308, described by non-parallel rotational vectors, via the multiple helices, with the swirls working in conjunction to provide an improved mixing process. When a fuel injector is mounted appropriately in the multi-axis helical crossover passage end piece, the fuel can begin to mix with the air as the air and fuel swirl and move through the opened valve. Additionally, the fuel can be injected for mixing into the multi-Axis rotating air swirl 304 and 308 after it has passed through the valve 305 and has entered the cylinder via direct cylinder fuel injection.

### Geometric Dilution

Geometric dilution is a process by which a homogenous mixture, or even distribution, of two or more substances is achieved. When using this method, a small quantity of an active ingredient, in the crossover-passage case, fuel, is mixed thoroughly with an approximately equal volume of diluent, in the crossover-passage case, air. More diluent is added, in a subsequent step, in an amount equal to the volume of the mixture generated in a former step. This process is repeated until a desired amount of the diluent is incorporated in the mixture.

The formula for any term of a geometric sequence is:

aₙ=a₁·rⁿ⁻¹,

where

a₁ is the first term of the sequence;

r is the common ratio; and

n is the position of the term in the sequence.

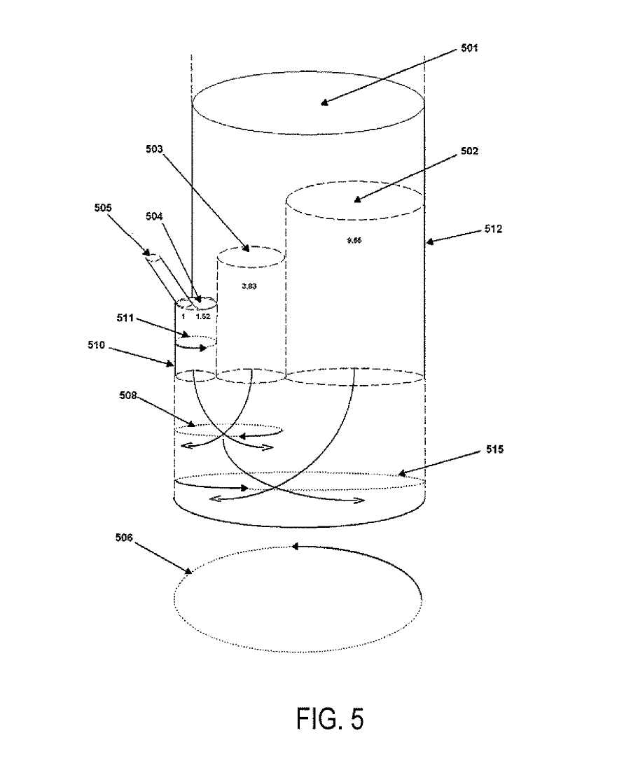

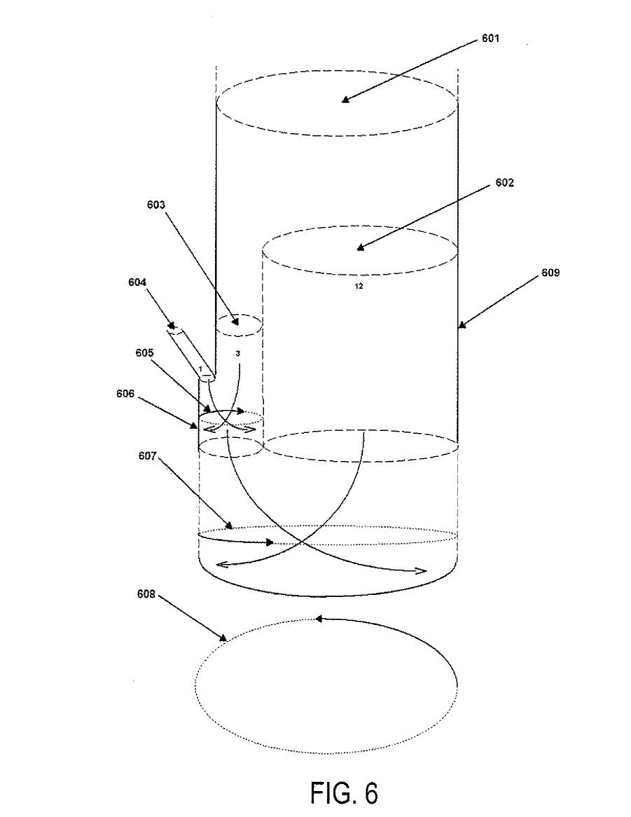

The common ratio is the ratio of each term in the sequence to the preceding term in the sequence. The common ratio for standard geometric dilution is 2. Depending on other variables, constraints, and design goals, other geometric sequences with different common ratios can be used as well as alternative sequences, such as arithmetic sequences. FIG. 5 and FIG. 6 diagram alternative sequences.

The geometric sequence to mix air and fuel to achieve a stoichiometric mixture is described below, given that the fuel is what is being mixed and the air is the diluent. The fuel, considered to be one part, is mixed and diluted with an equivalent one part of air. The resulting mixture is two parts in total. The two parts total of air and fuel is then mixed and diluted again with two parts of air, yielding a mixture totaling four parts. The four-part mixture is then mixed and diluted again by adding four parts of air, yielding a total of eight parts of mixture. The eight-part total is diluted one more time, by adding eight parts of air, to yield a total 16-part mixture which is 15 parts air to one part fuel, or 14.7 to 1, by reducing, by a small fraction, each of the diluent add-ins. To summarize, where A=air, F=fuel and AF=Air and Fuel:

1A+1F=2AF

2AF+2A=4AF

4AF+4A=8AF

8AF+8A=16AF

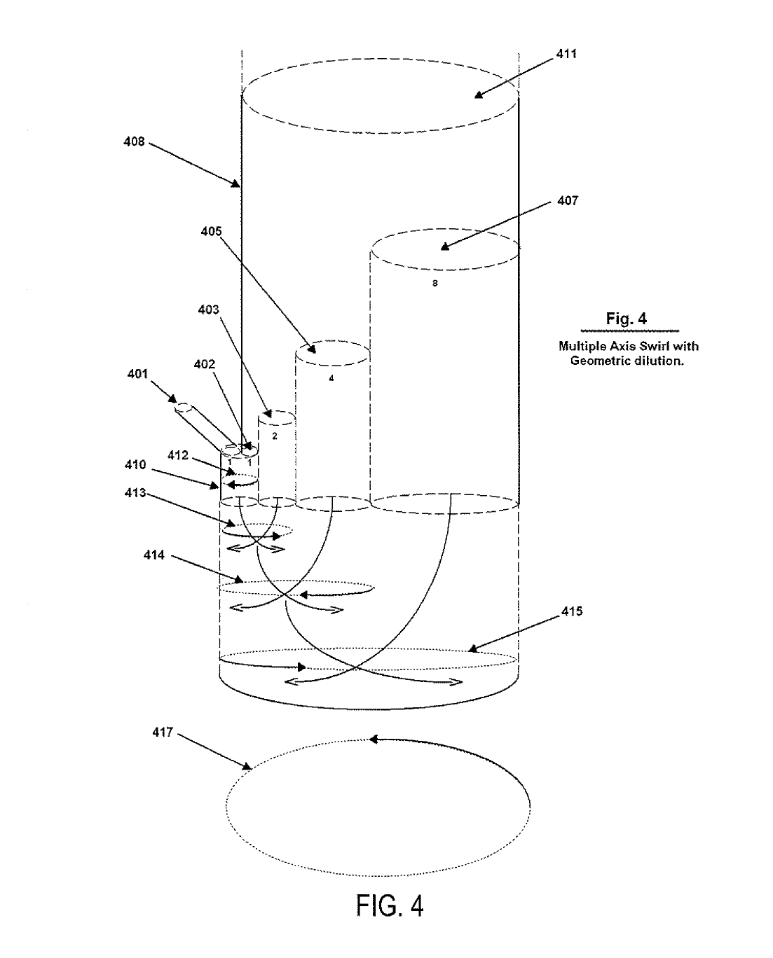

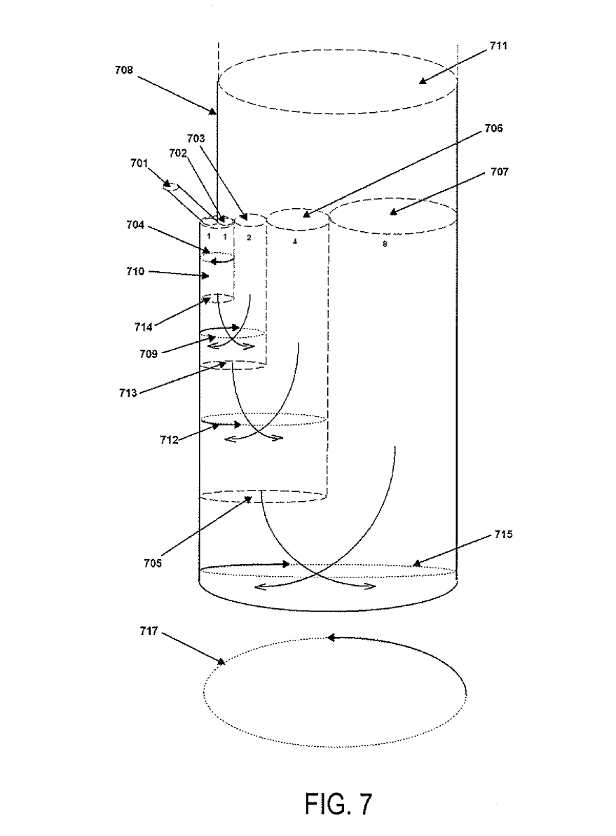

It is worthy to note that creation of all swirling stages, by the helical tubes, for geometric dilution of the fuel/air mixture can occur simultaneously and in parallel. The mixing, however, begins to occur in sequence as the fastest-frequency smaller-volume swirl contacts the fuel/air first and the slowest-frequency largest-volume air swirl contacts the fuel air last, both in variations which mix within the helical tubes, as exemplified by the example shown in FIG. 7, and in variations that mix outside the tubes in the swirl, as exemplified by the example shown in FIG. 4, excepting helical tube 410.

### Multiple Axis Helical Crossover Passage with Geometric Dilution

FIG. 4 shows a multi-axis helical crossover passage end piece that implements geometric dilution. For illustrative purposes, the multi-axis helical crossover passage end piece of FIG. 3 has been straightened and four separate straightened (again for illustrative purposes) helixes that replace the helical section 306 of FIG. 3 have been added. All of these helixes are shown straightened for viewing and simplicity of the descriptive process. Each section in this diagram that is helical is referred to as such. While the diagram and description refer to helical tubes, it is important to state that the current application does not disclose only helical tubes as the means to swirl the air/fuel. By way of example, the helical tubes may be replaced by scalloped vanes that split the air and cause it to swirl in a similar fashion. The advantage of vanes is that they reduce the surface area and associated air resistance. The tubes might cause potentially undesirable heating effects which a designer would seek to limit. With the fuel injector 401 as shown, the fuel/air mixture can begin to mix on valve opening in helical tube section 410 and mix as the swirling air/fuel moves through the valve mix as it swirls in the combustion cylinder.

### Splitting the Air

The multi-axis helical crossover passage end piece 408, which forms the larger outer helix, connects, at its air input 411, to the straight portion of the crossover passage of 107 coming from the compression cylinder 111. The input air is then divided into relative portions of eight parts air by helical tube 407, four parts air by helical tube 405, two parts air through helical tube 403, and one part air through input 402 of helical tube 410.

### Description of the Multiple Helical Tubes

With the exception of the Helical tube 410, the helical tubes create swirls that are used to mix outside the helical tubes. Mixing helix 410 creates a dual helix with helical tube 403. The dual helix 403•410 then twists with helical tube 405 forming another larger dual helix ((403•410)•405). Finally, helical tube 407 twists with ((403•410)•405) forming the final largest dual helix inside of the main helix 408. Each helix or dual helix is a fraction of a turn in rotation.

### Entwining the Swirling Fuel Air

The result of multi-axis helical crossover passage tube sections is that helical tube section 410 creates swirl 412 and combines one part of air from the fuel injector through input 401 and one part of air through input 402. On exit of section 410, the fuel/air mix swirls 413 to combine with the swirling air output from 403. This swirling fuel/air mix 413 then swirls 414 to combine with the swirling air from 405. This swirling fuel/air mix 414 then swirls and combines with the swirling output of 407 to create swirl 415, which also is acted upon by the outer helix 408 to swirl perpendicularly to the valve stem with swirl 417. The resulting output can be likened to a braided rope with the fuel entwined and twisted with the air in perfect proportion and location. Each braid, starting from smallest to largest, then dissolves into the next larger braid until a perfectly homogenous stoichiometric mixture is formed.

### Direction and Rotational Frequency of the Helical Twists

Swirls 412, 413, 414, and 415 are approximately parallel to the valve stem. Swirl 417 is perpendicular to the valve stem. The directions of 412, 413, 414, and 415 are shown alternating between counter-clockwise (“CCW”) and clockwise (“CW”) such that the adjacent rotations help interfere and mix each other. The frequency of the twists in the helical tubes runs progressively from fastest, for the shortest helical tube 410, to slowest, for longer outer helix 408. Although the helixes are shown straightened for illustrative purposes, the drawing is not to scale, so no inference to the actual frequencies can be assumed. The faster-frequency smaller-volume air fuel braids dissipate or dissolve into a homogenous mixture quickest. The next step, slower in frequency, corresponds to the next larger step in volume of air/fuel braids that dissipate or dissolve next, and so on, up until all the braids turn into one stoichiometric homogenous mixture.

### Alternate Geometric Sequences

FIG. 5 and FIG. 6 are diagrams of the third and fourth alternative implementations of the multi-axis helical crossover passage end piece. They implement non-optimal geometric dilution mixing sequences with a common ratio of 2.52 for FIG. 5 and a common ratio of 4 for FIG. 6. This overall scheme may be a better solution for certain scenarios. A common ratio of 2, with mixing 1 to 1 at each stage, where each part is equal, may produce an optimal mixture in certain circumstances.

### Explanation of FIG. 5

The helical end piece 512, which forms the larger outer helix, connects, at its air input 501, to the straight crossover passage of 107 coming from the compression cylinder 111. The input air is then divided into relative portions of 9.65 parts air by helical tube 502, 3.83 parts air by helical tube 503, and 1.52 parts air through helical input 504 of helical tube 510.

Mixing Helix 510 creates a dual helix with Helical tube 503. The dual helix 503•510 then twists with helical tube 502, forming another larger dual helix, ((503•510)•502), forming the final largest dual helix inside of the main helical shell 512. Each helix or dual helix is a fraction of a turn in rotation.

Helical tube section 510 creates swirl 511 and combines one part of air from the fuel injector through input 505 and 1.52 parts of air through input 504. On exit of section 510, the fuel/air mix swirls at 508 to combine with the swirling air output from helical section 503. This swirling fuel/air mix 508 then swirls at 415 to combine with the swirling air from 502, which also is acted upon by the outer helix 512 to swirl perpendicular to the valve stem with swirl 506. The resulting output can be likened to a braided rope, with the fuel entwined and twisted with the air in perfect proportion and location. Each braid, starting from smallest to largest, then dissolves into the next larger braid until a perfectly homogenous stoichiometric mixture is formed.

Swirls 511, 508, and 515 are approximately parallel to the valve stem. Swirl 506 is perpendicular to the valve stem. The directions of 511, 508, and 515 are shown alternating CCW and CW such that the adjacent rotations help interfere and mix each other. The frequency of the twists in the helical tubes runs progressively from fastest, for the shortest helical tube 510, to slowest, for longer outer helix 512. Although the helixes are shown straightened for illustrative purposes, the drawing is not to scale, so no inference to the actual frequencies can be assumed. The faster frequency smaller volume air/fuel braids dissipate or dissolve into a homogenous mixture quickest. The next step slower in frequency and next step larger in volume braids dissipate or dissolve next, and so on, up until all the braids turn into one stoichiometric homogenous mixture.

### Explanation of FIG. 6

The helical end piece 609, which forms the larger outer helix, connects at its air input 601 to the straight crossover passage of 107 coming from the compression cylinder 111. The input air is then divided into relative portions of 12 parts air by helical tube 602 and three parts air by helical input 603 of helical tube 606. Mixing helical swirl 605 then creates a swirl with the output of helical tube 602 at 607, forming the final dual helix inside of the main helical shell 609. Each helix or dual helix is a fraction of a turn in rotation.

The helical tube section 606 creates swirl 605 and combines one part from the fuel injector through input 505 and three parts of air through input 603. On exit of section 606, the fuel/air mix swirls at 607 to combine with the swirling air output from helical section 602, which also is acted upon by the outer Helix 609 to simultaneously swirl perpendicularly to the valve stem with swirl 506. The resulting output can be likened to a braided rope, with the fuel entwined and twisted with the air in perfect proportion and location. Each braid, starting from smallest to largest, then dissolves into the next larger braid until a perfectly homogenous stoichiometric mixture is formed.

Swirls 605 and 607 are approximately parallel to the valve stem. Swirl 608 is perpendicular to the valve stem. The directions of 605 and 607 are shown alternating CCW and CW such that the adjacent rotations help interfere and mix each other. The frequency of the twists in the helical tubes runs progressively from fastest for the shortest helical tube 606 to slowest for longer outer helix 609. Although the helixes are shown straightened for illustrative purposes, the drawing is not to scale so no inference to the actual frequencies can be assumed. The faster-frequency smaller-volume air fuel braids dissipate or dissolve into a homogenous mixture quickest. At the next step, slower in frequency and larger in volume braids dissipate or dissolve next, and so on, until all the braids turn into one stoichiometric homogenous mixture.

### Alternate Means of Mixing

FIG. 7 shows an inversion of the helical tube sequence that mixes geometrically in sequence within the tubes. This approach has the potential drawback that some of the pressurized air in the larger later stages could be released when the intake valve opens without first mixing with fuel if the valve timing is not done properly. This approach is more applicable to mixing within the crossover as detailed below. The amount of unmixed air can be minimized by using a combination of the mixing techniques of FIG. 4 and FIG. 7, mixing the first couple of stages within the helical tubes, as shown in FIG. 7, and mixing the last stages in the outer swirl, as shown in FIG. 4, with the first several stages mixed before the valve, in the helical tubes, and the majority of the air in the last stages mixed with fuel in the swirls after the valve. This combination technique has utility in that a stoichiometric mixture cannot be obtained prior to the valve thus staving off pre-detonation before the valve. As an example, were the helical sections mixed except for the air from helical tube input 707 prior to the valve, the mixture would be approximately seven parts air to one part fuel. Were all helical sections mixed except for air from helical tube input 707 and air from helical tube input 706, the mixture would only be three parts air to one part fuel prior to the valve. By employing the techniques of FIG. 5 and FIG. 6 and using alternate geometric sequences with this combination of mixing of FIG. 4 and FIG. 7, the approach can be further tailored to the Split cycle engine specifics.

The variations of the design shown in FIGS. 3, 4, 5, 6, and 7 allow for multiple modes of mixing above and beyond the Geometric dilution shown to be implemented and/or mixing swirls created by the various designs or their combinations. One such method is to control the inlet and outlet crossover valves to pressurize the crossover with air. Then fuel would be injected as the crossover outlet valve/combustion cylinder inlet valve is opened, initiating the necessary high-speed flow through the helical tubes to mix. A second option is to control the inlet and outlet valves to begin with an emptied crossover and then inject fuel as the crossover inlet valve is opened, again initiating a high speed flow, but in this case into the crossover. Then mixing can then be done entirely within the crossover, if desired. The combustion cylinder inlet valve can be opened as or slightly after this process begins thus emptying the crossover for the next cycle. This second option may be more desirable when an air-storage tank or main air manifold is added to the split cycle engine.

### Explanation of FIG. 7

The multi-axis helical crossover passage end piece 708, which forms the larger outer helix, connects at its air input 711 to the straight portion of the crossover passage of 107 coming from the compression cylinder 111. The input air is then divided into relative portions of eight parts air by helical tube input 707, four parts air by helical tube input 706, two parts air through helical tube input 703 and one part air through input 702 of helical fuel/air mixing tube 710.

### Description of the Multiple Helical Tubes

All of the helical tubes in the approach shown in FIG. 7 create twists that are used to begin mixing inside the helical tubes. Helix 710 creates a dual helix with helical tube 703. The dual helix 703•710 additionally twists at a higher level with helical tube 706 forming another larger dual helix ((703•710)•706). Finally, helical tube 707 twists with ((703•710)•706), forming the final largest dual helix inside of the main helical shell 708. Each helix or dual helix is a fraction of a turn in rotation.

### Entwining the Swirling Fuel Air

The result is that helical tube section 710, with internal mixing helical twist 704, combines one part of air from the fuel injector through input 701 and one part of air through input 702. On exit at 714, the fuel/air mix twists in 709 to combine with the swirling air output from 703. This swirling fuel/air mix exits at 713 then twists 712 to combine with the swirling air from 706. This swirling fuel/air mix exits 705 and twists 715 to combine with the swirling output of 707, which also is acted upon by the outer helix 708 to swirl perpendicularly to the valve stem with swirl 717. The resulting output can be likened to a braided rope with the fuel entwined and twisted with the air in perfect proportion and location. Each braid, mixing from smallest to largest, is dissolving into the next larger braid as a perfectly homogenous stoichiometric mixture is formed.

### Direction and Rotational Frequency of the Helical Twists

Helical twists 704, 709, 712, and 715 are multi-axis and, within the confines of the outer helical tube 708, run approximately parallel to the valve stem. Swirl 417 is created by 708, the larger helical tube runs perpendicular to the valve stem. The directions of 704, 709, 712, and 715 are shown alternating CCW and CW such that the adjacent rotations help interfere and mix each other on exit of each helical section. The frequency of the twists in the helical tubes runs progressively from fastest for the shortest helical tube 710 to slowest for longer outer helix 708. Although the helixes are shown straightened for illustrative purposes, the drawing is not to scale, so no inference to the actual frequencies can be assumed. The faster frequency smaller volume air fuel braids dissipate or dissolve into a homogenous mixture quickest. The next step slower in frequency correspond to the next step larger in volume air fuel braids dissipate or dissolve next and so on up until all the braids turn into one stoichiometric homogenous mixture.

Although the present invention has been described in terms of particular embodiments, it is not intended that the invention be limited to these embodiments. Modifications within the spirit of the invention will be apparent to those skilled in the art. For example, multiple helical tubes, passageways, or chambers can be combined within any of many different mixing channels, including in non-crossover portions of the split-cycle engine. The configurations, orientations, sizes, number of turns, and positional interrelationships between the multiple helices may be varied to implement a wide range of different possible mixing ratios, flow rates, and degrees of mixing needed for various different applications. The multiple helical tubes, passageways, or chambers may be manufactured from a variety of different materials appropriate to specific applications.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A multi-helical end piece within the crossover passage of a split cycle engine, the multi-helical end piece comprising:
an input connection to a compression cylinder;
an internal passageway comprising two helixes, the axes of the two helices non-parallel; and
an output connection to a combustion cylinder.

2. The multi-helical end piece of claim 1 wherein the internal passageway comprises one or more additional helixes.

3. The multi-helical end piece of claim 1 wherein a mixture of fluids, such as gasses or liquids, is geometrically diluted by the multi-helical end piece.

4. The multi-helical end piece of claim 3 wherein input air is divided into input streams input to each of the multiple helices.

5. The multi-helical end piece of claim 4 wherein fuel is input, along with air, into a single helix.

6. The multi-helical end piece of claim 5 wherein the single helix, into which fuel is input, imparts a rotational velocity to the fuel/air mixture output from the single helix that is greater than the rotational velocities imparted to air output from the remaining helices.

7. A multi-helical mixing passage comprising:
an input;
an internal passageway comprising two helixes, the axes of the two helices non-parallel; and
an output.

8. The multi-helical mixing passage of claim 7 wherein the internal passageway comprises one or more additional helixes.

9. The multi-helical mixing passage of claim 7 wherein a mixture of fluids, such as gasses or liquids, is geometrically diluted by the multi-helical mixing passage.

10. The multi-helical mixing passage of claim 9 wherein a first input fluid is divided into input streams input to each of the multiple helices.

11. The multi-helical mixing passage of claim 10 wherein a second fluid is input, along with a portion of the first fluid, into a single helix.

12. The multi-helical mixing passage of claim 11 wherein the single helix, into which the second fluid is input, imparts a rotational velocity to the fluid mixture output from the single helix that is greater than the rotational velocities imparted to fluid output from the remaining helices.
